(19) United States
(12) Patent Application Publication
(10) Pub. No.: US 2004/0062261 A1
(43) Pub. Date: Apr. 1, 2004

(54) Multi-service segmentation and reassembly device having integrated scheduler and advanced multi-timing wheel shaper

(76) Inventors: Rami Zecharia, Sunnyvale, CA (US); Bidyut Parruck, Cupertino, CA (US); Chunalur Ramakrishnan, Saratoga, CA (US)

Correspondence Address: Silicon Edge Law Group, LLP, T. Lester Wallace, Suite 245, 6601 Koll Center Parkway, Pleasanton, CA, 94566, US

(21) Appl. No.: 10/670,904

(22) Filed: Sep. 25, 2003

Related U.S. Application Data
(63) Continuation-in-part of application No. 09/851,565, filed on May 8, 2001.
(63) Continuation-in-part of application No. 09/823,667, filed on Mar. 30, 2001.
Application No. 09/823,667 is a continuation-in-part of application No. 09/779,381, filed on Feb. 7, 2001.
(60) Provisional application No. 60/434,554, filed on Dec. 18, 2002.

(51) Int. Cl. H04L 12/56

(52) U.S. Cl. 370/419; 370/395.3

(57) ABSTRACT

A multi-service segmentation and reassembly (MS-SAR) integrated circuit is disposed on a line card in a router or switch. The MS-SAR can operate in an ingress mode so that it receives packet and/or cell format data and forwards that data to either a packet-based or a cell-based switch fabric. The MS-SAR can also operate in an egress mode so that it receives data from either a packet-based or a cell-based switch fabric and outputs that data in packet and/or cell format. The MS-SAR has a data path through which many flows of different traffic types are processed simultaneously. Control path circuitry includes a port calendar, a scheduler and an advanced multi-timing wheel shaper. The MS-SAR can be programmed such individual flows are shaped, or scheduled, or both.

### CROSS-REFERENCE TO RELATED APPLICATION

This application claims the benefit under 35 U.S.C. §119 of Provisional Application 60/434,554, filed Dec. 18, 2002. The entire content of Provisional Application 60/434,554 is incorporated herein by reference.

### DETAILED DESCRIPTION

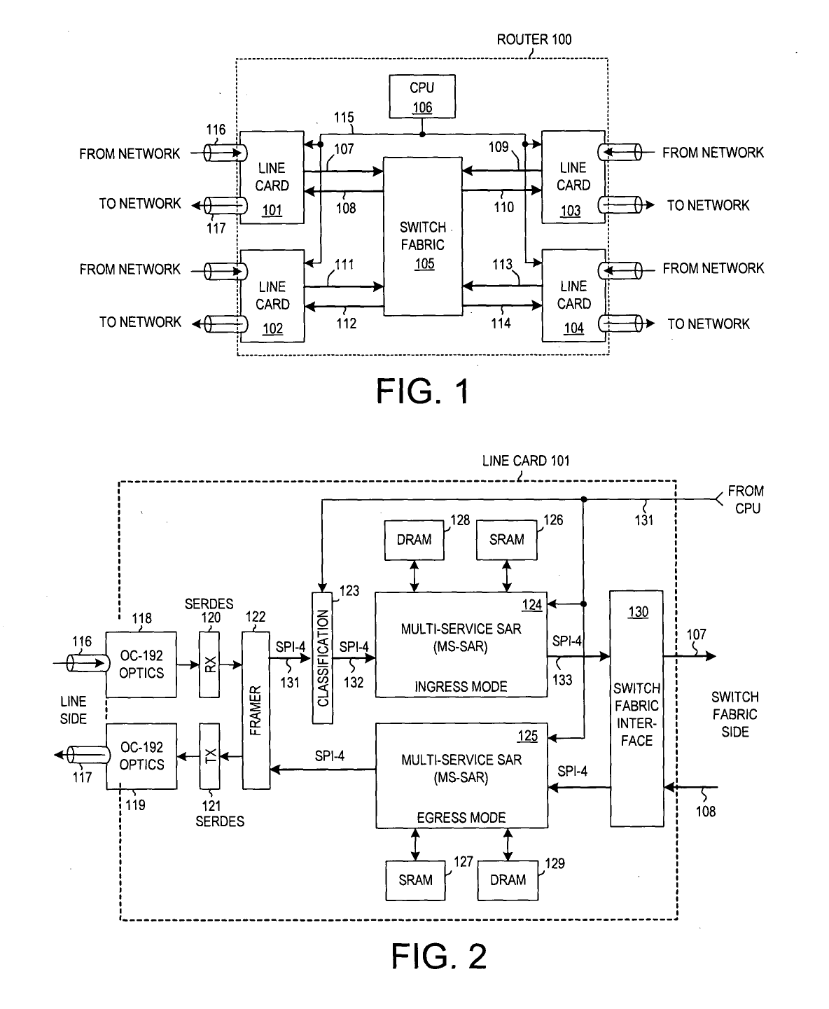

FIG. 1 is a simplified diagram of a router 100 in accordance with an embodiment of the present invention. Router 100 includes a plurality of line cards 101-104, a switch fabric 105 and a central processing unit (CPU) 106. The line cards 101 -104 are coupled to switch fabric 105 by buses 107-114. CPU 106 is coupled to line cards 101-104 by another parallel bus 115. In the present example, parallel bus 115 is a 32-bit PCI bus. In this example, each of the line cards can receive network communications in multiple formats. For example, line card 101 is coupled to a fiber optic cable 116 such that line card 101 can receive from cable 116 network communications at OC-192 rates in packets and/or ATM cells.

Line card 101 is also coupled to a fiber optic cable 117 such that line card 101 can output onto cable 117 network communications at OC-192 rates in packets and/or ATM cells. All the line cards 101-104 in this example have substantially identical circuitry.

FIG. 2 is a more detailed diagram of representative line card 101. Line card 101 includes OC-192 optical transceiver modules 118 and 119, two serial-to-parallel devices (SERDES) 120 and 121, a framer integrated circuit 122, an IP classification engine 123, two multi-service segmentation and reassembly devices (MS-SAR devices) 124 and 125, static random access memories (SRAMs) 126 and 127, dynamic random access memories (DRAMs) 128 and 129, and a switch fabric interface 130. IP classification engine 123 may, in one embodiment, be a classification engine available from Fast-Chip Incorporated, 950 Kifer Road, Sunnyvale, Calif. 94086. Framer 122 may, in one embodiment, be a Ganges S19202 STS-192 POS/ATM SONET/SDH Mapper available from Applied Micro Circuits Corporation, 200 Brickstone Square, Andover, Mass. 01810. MS-SAR devices 124 and 125 are identical integrated circuit devices, one of which (MS-SAR 124) is configured to be in an “ingress mode”, the other of which (MS-SAR 125) is configured to be in an “egress mode”. Each MS-SAR device includes a mode register that is written to by CPU 106 via bus 115. When router 100 is configured, CPU 106 writes to the mode register in each of the MS-SAR devices on each of the line cards so as to configure the MS-SAR devices of the line cards appropriately.

Fiber optic cable 116 of FIG. 2 can carry information modulated onto one or more of many different wavelengths (sometimes called “colors”). Each wavelength can be thought of as constituting a different communication channel for the flow of information. Accordingly, optics module 118 converts optical signals modulated onto one of these wavelengths into analog electrical signals. Optics module 118 outputs the analog electrical signals in serial fashion to Serdes 120. Serdes 120 receives this serial information and outputs it in parallel form to framer 122. Framer 122 receives the information, frames it, and outputs it to classification engine 123 via SPI-4 bus 131. Classification engine 123 performs IP classification and outputs the information to the ingress MS-SAR 124 via another SPI-4 bus 132. The ingress MS-SAR 124 processes the network information in various novel ways (explained below), and outputs the network information via to switch fabric 105 (see FIG. 1) via SPI-4 bus 133, switch fabric interface 130, and bus 107. All the SPI-4 buses of FIGS. 1 and 2 are separate SPI-4, phase II, 400 MHz DDR buses having sixteen bit wide data buses.

Switch fabric 105, once it receives the network information, supplies that information to one of the line cards of router 100. Each of the line cards is identified by a “virtual output port” number. To facilitate the rapid forwarding of such network information through the switch fabric 105, network information passed to the switch fabric 105 for routing is provided with a “switch header”. The “switch header” may be in a format specific to the manufacturer of the switch fabric of the router. The switch header identifies the “virtual output port” to which the associated network information should be routed. Switch fabric 105 uses the virtual output port number in the switch header to route the network information to the correct line card.

Router 100 determines to which of the multiple line cards particular network information will be routed. Accordingly, the router's CPU 106 provisions lookup information in (or accessible to) the ingress MS-SAR 124 so that the MS-SAR 124 will append an appropriate switch header onto the network information before the network information is sent to the switch fabric 105 for routing. Switch fabric 105 receives the network information and forwards it to the line card identified by the particular “virtual output port” in the switch header. The network information and switch header is received onto the egress MS-SAR of the line card that is identified by the virtual output port number in the switch header.

For explanation purposes, MS-SAR 125 in FIG. 2 will represent this egress MS-SAR. The egress MS-SAR 125 receives the network information, removes the switch header, performs other novel processing (explained below) on the network information, and outputs the network information to framer 122. Framer 122 outputs the network information to serdes 121. Serdes 121 converts the network information into serial analog form and outputs it to output optics module 119. Output optics module 119 converts the information into optical signals modulated onto one wavelength channel. This optical information is then transmitted from router 100 via fiber optic cable 117.

MS-SAR in More Detail:

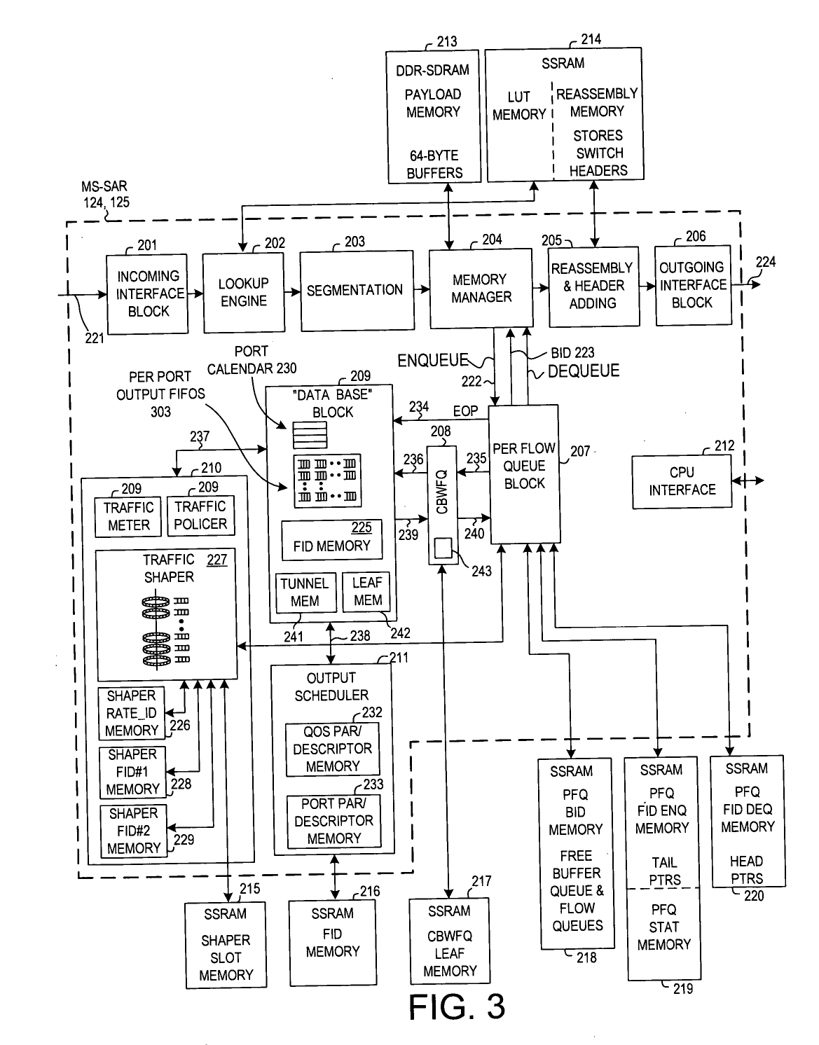

FIG. 3 is a more detailed diagram of an MS-SAR device 124 in accordance with an embodiment of the present invention. MS-SAR device 124 includes an incoming interface block 201, a lookup engine block 202, a segmentation block 203, a memory manager block 204, a reassembly and header-adding block 205, an outgoing interface block 206, a per flow queue (PFQ) block 207, a class-based weighted fair queuing (CBWFQ) block 208, a data base (DBS) block 209, a traffic shaper block 210, an output scheduler block 211, and a CPU interface block 212. MS-SAR 124 interfaces to and uses numerous other external memory integrated circuit devices 213-220 that are disposed on the line card along with the MS-SAR.

In operation, MS-SAR 124 receives a flow of network information via input terminals 221. When incoming interface block 201 accumulates a sufficient amount of the network information, it forwards the information to lookup block 202. CPU 106 (see FIG. 1) has previously placed lookup information into MS-SAR 124 so that header information in the incoming network information (in the case of MS-SAR being used in the ingress mode) can be used by lookup block 202 to find: 1) a particular flow ID (FID) for the flow that was specified by CPU 106, and 2) an application type. The application type, once determined, is used by other blocks of MS-SAR 124 to configure themselves in the appropriate fashion to process the network information appropriately.

The FID and application type, once determined, are passed to segmentation block 203. Segmentation block 203 performs various operations on the associated network information and then forwards the information to memory manager block 204.

External payload memory 213 contains a large number of 64-byte buffers, each buffer being addressed by a buffer identifier (BID). When memory manager block 204 receives a 64-byte chunk (also called a “cell”) of information associated with the flow, memory manager block 204 issues an “enqueue” command via enqueue command line 222 to per flow queue block 207. This constitutes a request for the per flow queue block 207 to return the BID of a free buffer. Per flow queue block 207 responds by sending memory manager block 204 the BID of a free buffer via lines 223. Memory manager block 204 then stores the 64-byte chunk of information in the buffer in payload memory 213 identified by the BID.

Per flow queue block 207 maintains a linked list (i.e., a “queue”) of the BIDs for the various 64-byte chunks of each flow that are stored in payload memory 213. Such a linked list is called a “per flow queue”. Once the linked list (queue) for the flow is formed, the linked list can be popped (i.e., dequeued) in a particular way and at such a rate that the associated chunks of information stored in payload memory 213 are output from MS-SAR 124 in a desired fashion. To perform a dequeue operation, per flow queue block 207 accesses the per flow queue of the flow ID, determines the next BID for the FID to be dequeued, and outputs that BID in the form of a “dequeue command” to memory manager block 204. Memory manager block 204 uses the BID to retrieve the identified chunk from payload memory 213 and outputs that chunk to reassembly block 205. Reassembly block 205 performs other actions on the chunk and then outputs the chunk from MS-SAR 124 via outgoing interface block 206 and output terminals 224.

It is therefore seen that the output from MS-SAR 124 of chucks (i.e., cells) for a particular FID can be controlled by controlling when dequeue commands for the FID are sent to memory manager block 204. Operation of the remaining blocks (207-211) of MS-SAR 124 is directed to a “control path” whereby this dequeuing process is controlled so as to achieve desired traffic shaping, traffic scheduling, traffic policing, and traffic metering functions.

Simplified Overview of Control Path Input Phase Operation:

Operation of the control path portion of MS-SAR 124 is explained in terms of an “input phase” and an “output phase”. Before a chunk for an FID is received and stored in payload memory 213, MS-SAR 124 is first provisioned with information on how the FID is to be shaped and/or scheduled. This provisioning is done via CPU interface block 212.

An input phase begins when a chunk for an FID (FID3 in this example) is to be stored in payload memory 213. Per flow queue (PFQ) block 207 supplies a BID to memory manager block 204 and then links the BID to the per flow queue for the particular FID. FPQ block 207 then forwards the FID to CBWFQ block 208 via lines 235. We assume now for ease of explanation in this simplified introductory example that CBWFQ block 208 does not merge the FID with any other FID. The FID therefore passes through CBWFQ block 208 to DBS block 209 via lines 236. MS-SAR 124 in this example has been provisioned beforehand to shape FID3 (rather than to schedule FID3). DBS block 209 includes a DBS internal FID memory 225 that is provisioned beforehand to contain, for each FID, a set of parameters.

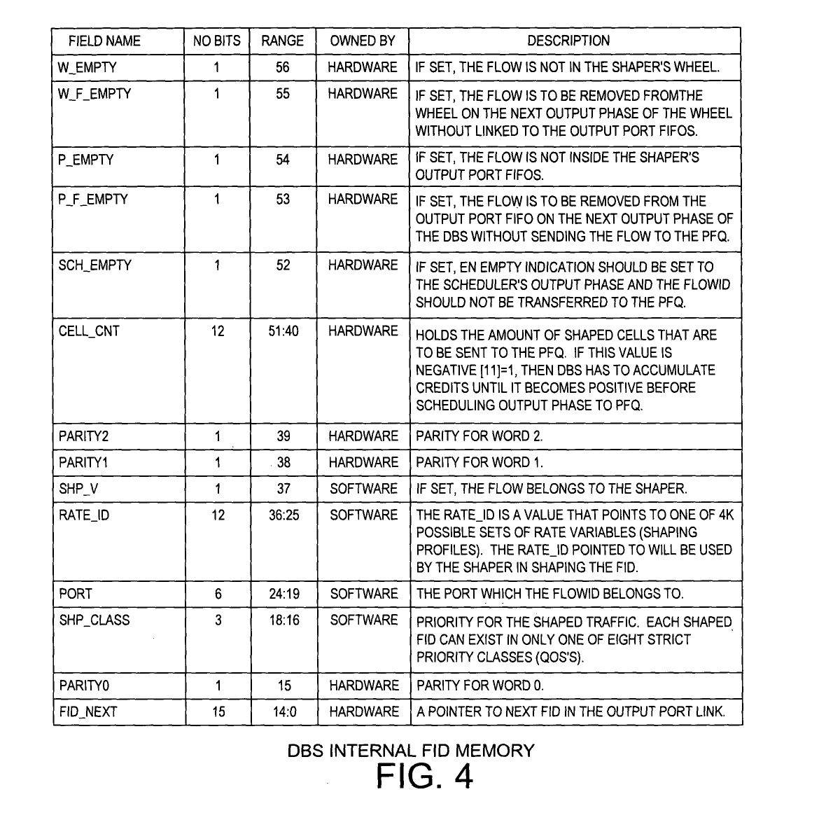

FIG. 4 is a diagram of one such set of parameters in DBS internal FID memory 225. One parameter is a Rate_ID. The Rate_ID value stored for the FID identifies one of a set of rate variables. Each of these sets of rate variables is called a “rate profile”. The rate profiles are stored in shaper internal Rate_ID memory 226. Each profile is identified by its own Rate_ID.

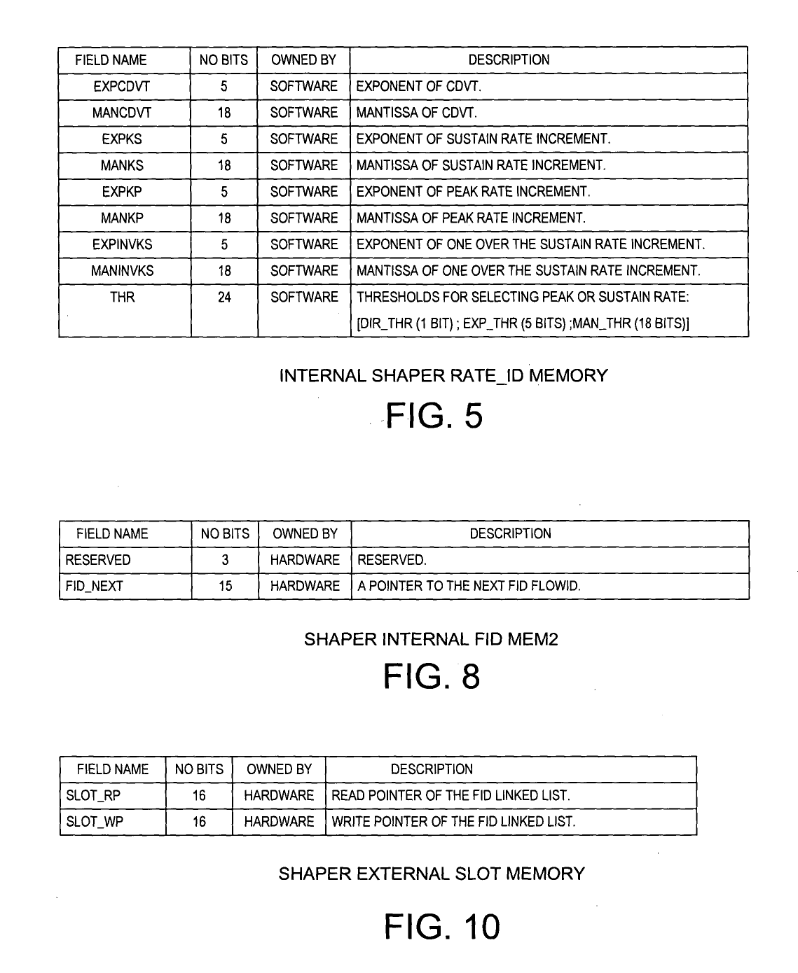

FIG. 5 is a diagram of one rate profile (for one Rate_ID) as the profile is stored in shaper internal Rate_ID memory 226. The various rate variables of the profile determine how shaper portion 227 of shaper block 210 will shape the associated FID. Using the FID number (FID3 in this case) as the base address, DBS block 209 looks up the Rate_ID value stored in DBS internal FID memory 225 for FID3, and then forwards that Rate_ID along with the FID number and other FID-specific values to both shaper block 210 as well as to scheduler block 211. The information is sent to shaper block 210 via lines 237. The information is sent to scheduler block 211 via lines 238. Two additional bits are also sent to indicate that the shaper block, and not the scheduler block, is to perform an input phase for FID3.

Shaper block 210 shapes the incoming FID3 with a particular rate identified by the Rate_ID value by first linking FID3 in a “shaper input phase” to an appropriately distant future “slot” on a “timing wheel”. FIG. 6 is a conceptual diagram of a timing wheel 300 before FID3 is linked to it. A different linked list of FIDs can be linked to each of the various slots of timing wheel 300. Conceptually, the timing wheel rotates at a constant rate such that the slot number for each slot is decremented once each slot time. In this example, a slot time is eight cycles of the 200 MHz system clock. When the slot to which an FID is linked becomes slot zero, then all FIDs linked to that slot are output from the wheel. Accordingly, the future slot to which the incoming FID3 is linked in this example will determine the amount of delay until FID3 will be output. If FID3 is linked to a slot well into the future, then it will take longer for the wheel to rotate to that slot. The particular slot to which FID3 is linked therefore determines the rate at which FID3 will be shaped. The shaper input phase involves calculating the particular future slot to which FID3 will be linked in order to achieve the programmed shaping rate determined by the Rate_ID.

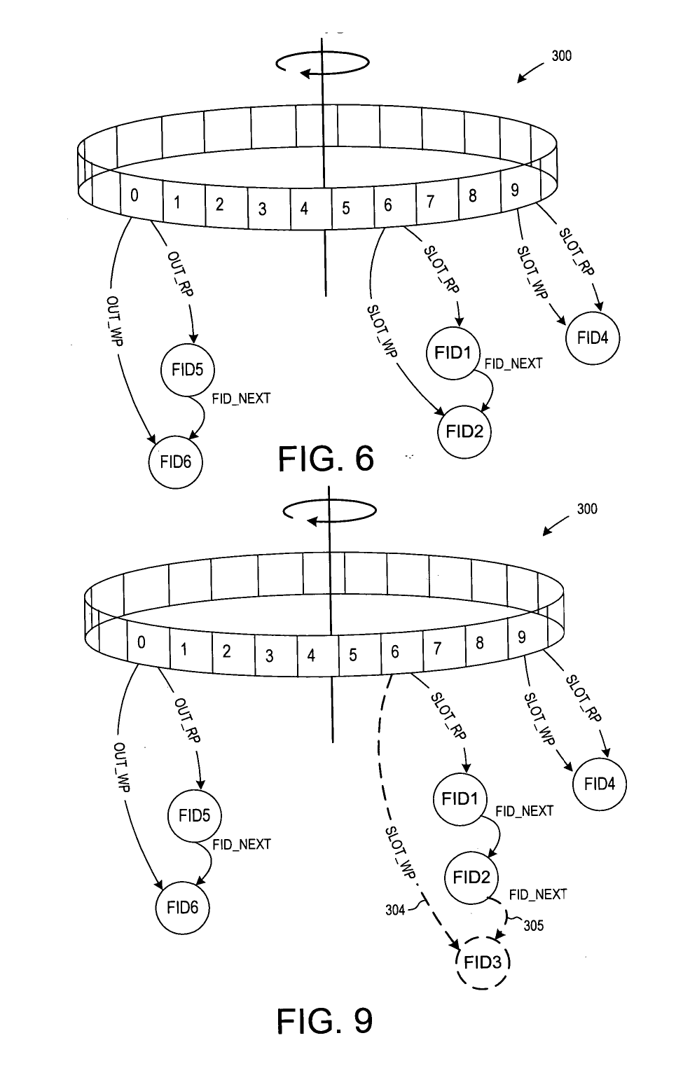

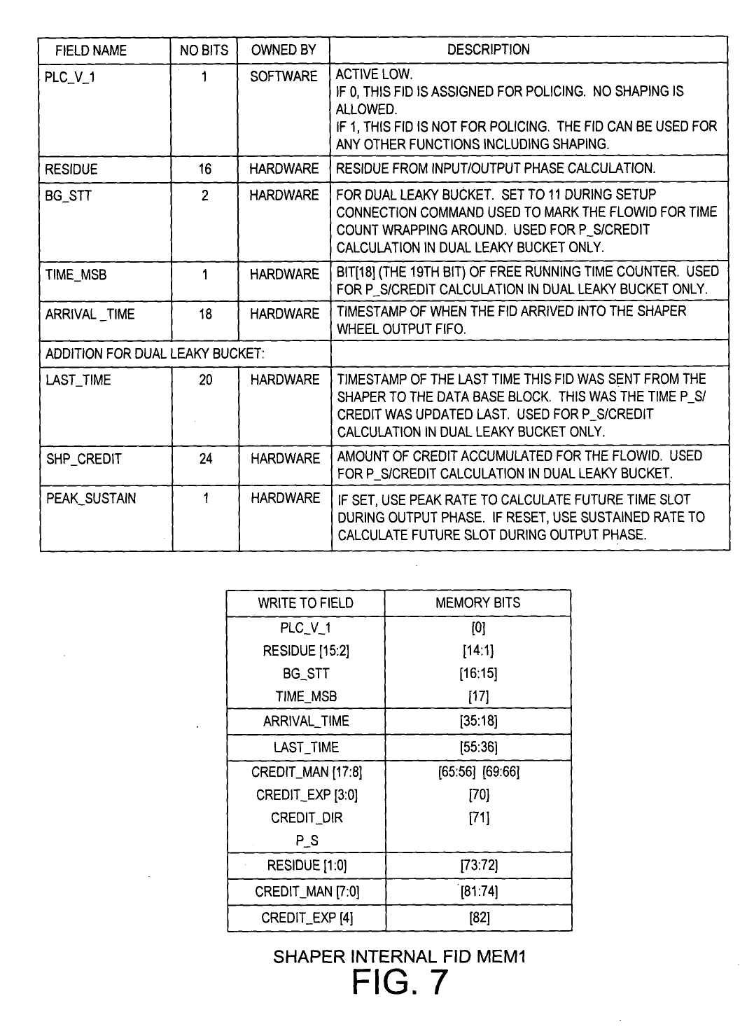

Using the rate information retrieved from internal Rate_ID memory 226 as well as other information for the FID stored in shaper internal FID#1 and FID#2 memories 228 and 229, traffic shaper portion 227 determines the future time slot to which FID3 should be linked. FIG. 7 is a diagram of shaper internal FID#1 memory 228. FIG. 8 is a diagram of shaper internal FID#2 memory 229.

FIG. 9 is a diagram illustrating how shaper block 210 links FID3 to wheel 300. In the present example, shaper portion 227 determines that FID3 is to be linked to slot number six. There is already a linked list of two FIDs (FID1 and FID2) linked to slot number six. As illustrated, for each slot on the wheel there is a SLOT_RP read pointer and a SLOT_WP write pointer. The slot read and slot write pointers for slot six point to the associated linked list of FIDs. The read and write slot pointers for all the slots of the wheel are stored in shaper external slot memory 215. FIG. 10 is a diagram of the pair of read and write slot pointers for one slot on one wheel as that pair of slot pointers is stored in shaper external slot memory 215.

To add FID3 to the linked list on slot number six, the SLOT_WP write pointer is changed to point to FID3. This is indicated in FIG. 9 by dashed line 304. Each FID linked to a slot has a FID_NEXT pointer that can be set to point to a subsequent FID in a linked list. The FID_NEXT pointer for each FID is stored in shaper internal FID#2 memory 229 (see FIG. 8). To complete the linking of FID3 to the linked list on slot number six, the FID_NEXT pointer for FID2 is changed to point to FID3. This is indicated in FIG. 9 by dashed line 305. With the slot write pointer SLOT_WP set to point to added FID3 and with the FID_NEXT pointer for FID2 set to point to the added FID3, FID3 is linked to slot number six as illustrated in FIG. 9.

As set forth above, timing wheel 300 rotates at a constant rate of one slot time per every eight cycles of the 200 MHz system clock. When the slot at which FID3 is linked reaches the zero position, then FID3 is output from wheel 300 and is pushed into a “shaper output FIFO” in shaper portion 227. In this way, the timing wheel 300 continues to rotate and to fill the wheel's shaper output FIFO.

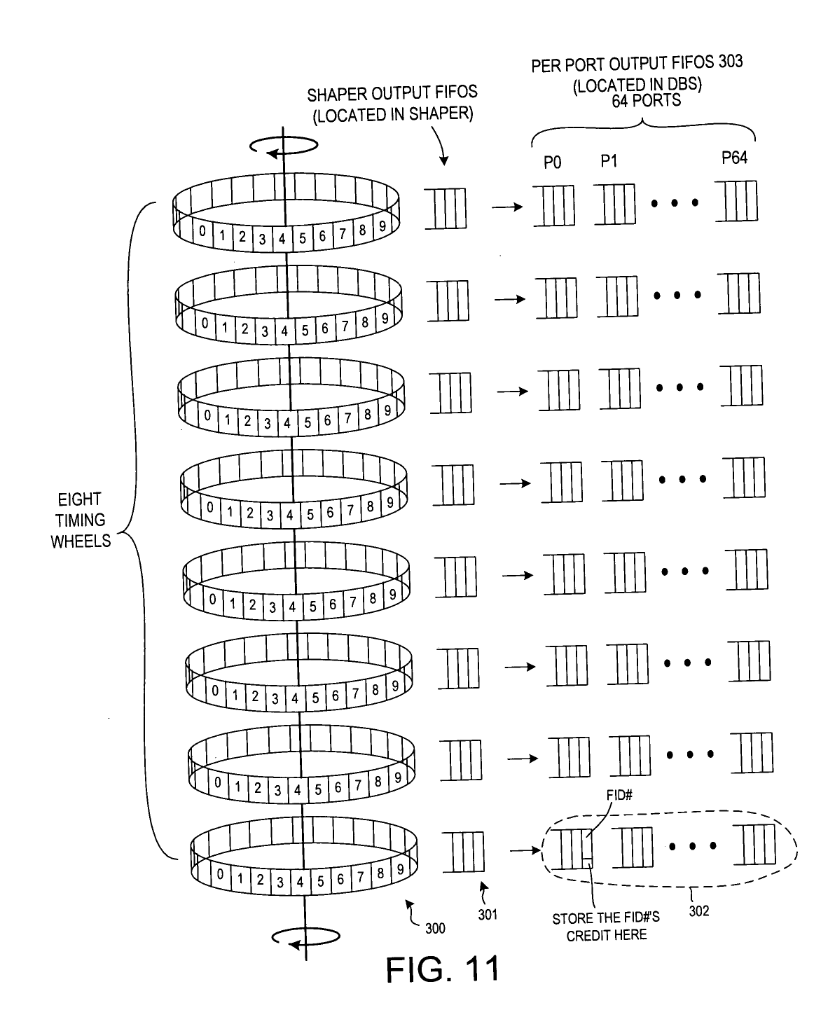

FIG. 11 is a diagram of eight timing wheels implemented by shaper block 210. Wheel 1 is the highest priority wheel, wheel 2 is the next highest priority wheel, and so forth. The eight timing wheels all rotate in unison at a constant rate. As illustrated, each of the eight timing wheels has its own “shaper output FIFO” into which it places FIDs. Shaper output FIFO 301 is the shaper output FIFO for the eighth timing wheel 300.

MS-SAR 124 is provisioned such that each FID to be shaped is preprogrammed to go out on an assigned output port. The output port number for each FID is stored in DBS internal FID memory 225. The output port number for FID3 was previously passed by DBS block 209 over lines 237 to shaper block 210 along with the FID. One by one, shaper portion 227 moves FIDs from the “shaper output FIFOs” to an associated plurality of “per-port output FIFOs” 303 in DBS block 209. Provided an FID is present in a shaper output FIFO, there is one such FID moved per wheel during each slot time. As illustrated in FIG. 11, there are sixty-four such “per-port output FIFO” in DBS block 209 for each wheel, there being one “per-port output FIFO” for each of the sixty-four possible output ports. The per-port output FlFOs 303 in DBS block 209 therefore form an 8×64 matrix of per-port output FIFOs. The particular per-port output FIFO to which the FID is moved is determined by the output port number stored for FID3 in FID memory 225.

FIG. 11 illustrates how this is done. For each FID stored in a per-port output FIFO, an associated “DBS credit” value is also stored. If the FID to be moved into a per-port output FIFO is already present in the per-port output FIFO, then the associated “DBS credit” number for that FID is incremented. The “DBS credit” for the FID therefore accumulates at the configured shaping rate.

When an FID is moved from a shaper output FIFO to a per-port output FIFO, the FID can either be “not-empty” (DBS block 209 indicates that there are more cells for this FID) or the FID can be “empty” (DBS block 209 indicates that there are no more cells for this FID). If the FID is “not-empty” then the FID is reattached to the timing wheel at a new time slot. The new slot is calculated based on the Rate_ID for the FID, how many slot times the FID was sitting in the shaper output FIFO waiting to be moved to a per-port output FIFO, and some other parameters. If the FID is “empty”, then the FID is not reattached. In this way, the FIDs of the chunks (cells) being stored in payload memory 213 are placed by shaper block 210 into the per-port output FIFOs in DBS block 209.

In the simplified example described so far, MS-SAR 124 was provisioned to shape FID3. If rather than shaping FID3, MS-SAR 124 had been provisioned to schedule FID3, then the input phase may have proceeded in accordance with the simplified input phase set forth below. As in the example above, DBS block 209 initially forwards the FID (FID3 in this case) to both shaper block 210 as well as scheduler block 211. In this example, however, the two additional bits that accompany the FID would indicate that the scheduler, and not the shaper, is to perform an input phase for FID3.

Upon receiving the FID, scheduler block 211 links the FID into a linked list of FIDs maintained for a single priority class and a single output port. The priority class is called a “quality of service” (QOS). There are eight possible QOSs. Accordingly, for each port, there can be up to eight such linked lists of FIDs (one linked list for each QOS).

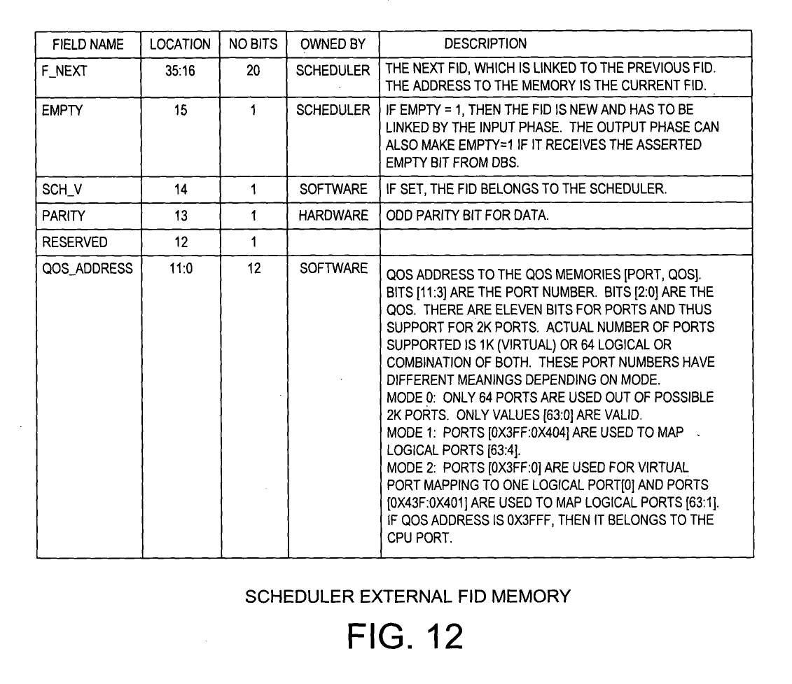

For each FID, a QOS_ADDRESS is provisioned beforehand into scheduler external FID memory 216. This QOS_ADDRESS contains three bits that identify the one QOS assigned to this FID, and eight bits that identify the output port to which this FID is to be scheduled. FIG. 12 is a diagram of the fields in scheduler external FID memory 216 that pertain to one FID.

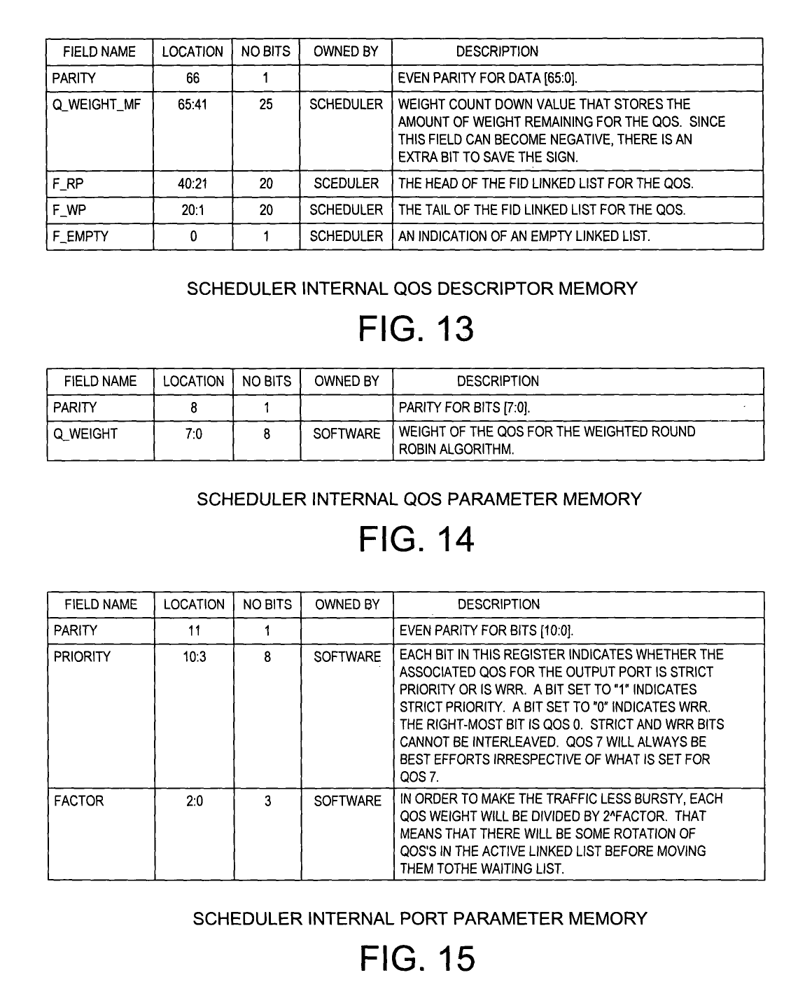

The QOS_ADDRESS also points to one of a plurality of “QOS descriptors” in an internal QOS parameter/descriptor memory 232. FIG. 13 is a diagram of the QOS descriptor portion of the scheduler internal QOS par/descriptor memory 232 and FIG. 14 is a diagram of the QOS parameter portion of the scheduler internal QOS par/descriptor memory 232. The QOS descriptor pointed to by QOS_ADDRESS identifies a read pointer F_RP that points to the head of the linked list of FIDs for the QOS and a write pointer F_WP that points to the tail of the linked list of FIDs for the QOS. Scheduler block 211 uses these pointers to link the incoming FID3 into the correct linked list of FIDs (the linked list for the indicated QOS and for the correct output port). Scheduler block 211 does this by updating the read and write pointers for the QOS (stored in QOS par/descriptor memory 232) in a fashion analogous to how the FID was added to the linked list connected to slot six of timing wheel 300 as described above.

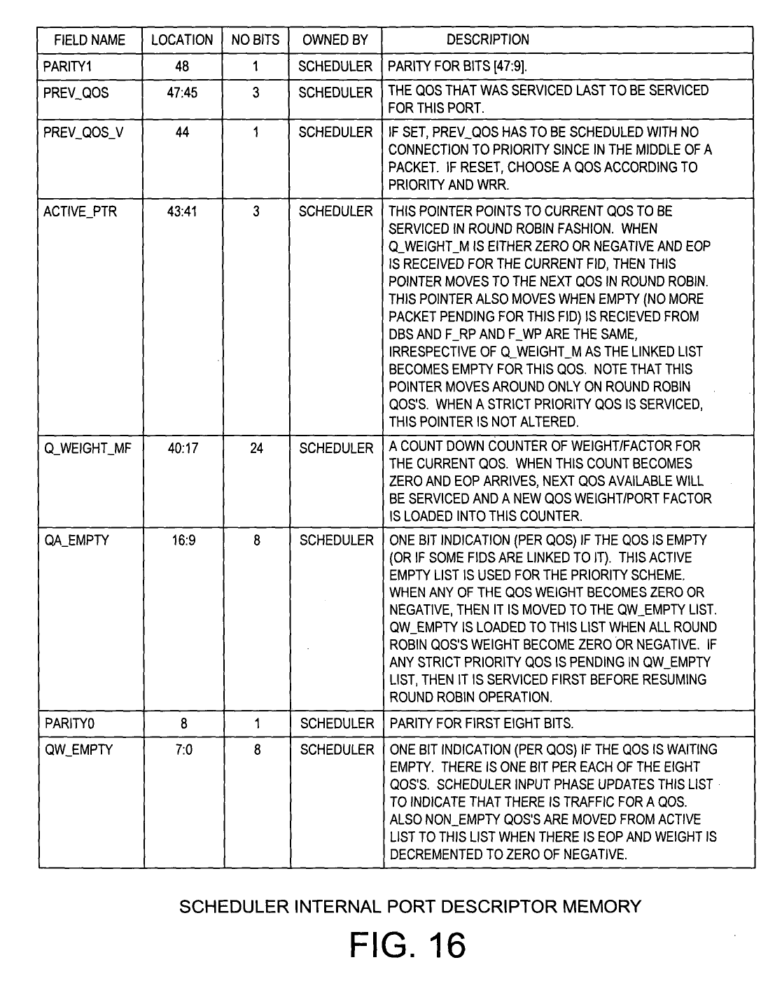

In addition to linking the incoming FID3 into the correct linked list of FIDs, the scheduler block 21 also sets a bit associated with the correct output port to indicate that the correct output port now has traffic (i.e., is now not empty). Scheduler block 211 does this by writing an appropriate value into an eight-bit QW_EMPTY field in an internal port parameter/descriptor memory 233. There is one bit in the QW_EMPTY field for each QOS of the output port. FIG. 15 is a diagram of the scheduler internal port parameter memory portion of the port par/descriptor memory 233, and FIG. 16 is a diagram of the scheduler internal port descriptor memory portion of the port par/descriptor memory 233. Once the QW_EMPTY field is been updated, the input phase is concluded. This concludes the simplified overview of the input phase of the control path.

Simplified Overview of Control Path Output Phase Operation

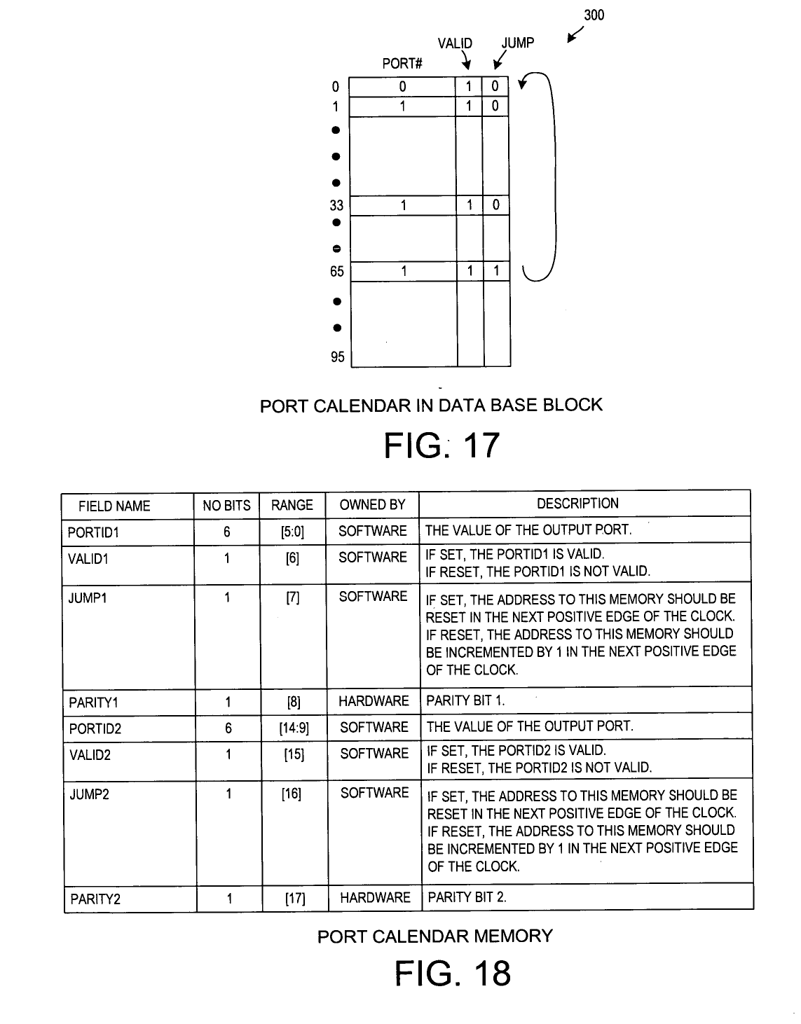

FIG. 17 is a diagram that illustrates a port calendar 230 that is located in DBS block 209. An output phase begins when this port calendar 230 informs shaper block 210 and scheduler block 211 of an output port that is due for dequeue processing. Port calendar 230 can be conceptualized as a rotating list where each row entry indicates an output port. There can be up to 96 row entries in the list. The row entries in port calendar 230 are serviced one by one down the list until a row entry is encountered that has its “jump” bit set. The jump bit being set causes the next row entry serviced to be the first row entry in the calendar. The servicing of row entries is therefore done in a round robin fashion. Each row entry corresponds to the bandwidth capacity of STS-1. Each row entry is serviced in eight clocks of the 200 MHz system clock. If it is desired to dedicate a greater percentage of bandwidth to one output port than to other output ports, then the one output port may be designated in more than one row in port calendar 230. For example, to configure various of the MS-SAR output ports to have STS-1, STS-3, and STS-12 bandwidths, the STS-1 output ports would be assigned one row each in the port calendar, the STS-3 output ports would be assigned three rows each in the port calendar, and the STS-12 output ports would be assigned twelve rows each in the port calendar. In the example set forth in FIG. 17, port calendar 230 holds one row entry for Port 0 (an STS-1 port) but it holds three row entries for Port 1 (an STS-3 port).

Once port calendar 230 has identified an output port for servicing, the output port number is sent to the shaper block 210 and to the scheduler block 211. Either the shaper block 210 or the scheduler block 211, or both, may then undergo output phases to provide FIDs back to DBS block 209 for dequeuing. If both the shaper block 210 and the scheduler block 211 provide FIDs, then DBS block 209 accepts the FID provided by shaper block 210 for dequeuing. If DBS block 209 accepts the FID from shaper block 210 when scheduler block 211 has also provided an FID, then the output phase of scheduler block 211 is aborted such that scheduler block 211 cannot change any values in memories 232, 233 or 216. By not allowing the values in memories 232, 233 and 216 to change, the output phase of scheduler block 211 is effectively reversed as if it never happened.

Output phase operation of shaper block 210 is now explained in more detail in connection with FIG. 11. As described previously, shaper block 210 in the input phase placed FIDs into the 8×64 matrix of per-port output FIFOs 303 located in DBS block 209. Now, in the output phase, FIDs are removed one by one from the per-port output FlFOs 303 in strict priority fashion. For example, an FID will be removed from a per-port output FIFO of the highest priority wheel (wheel one) if there is an FID in the associated per-port output FIFO for the selected port. If there are no FIDs in the per-port output FIFO for the selected port for wheel one (the highest priority wheel), then an FID is removed from the per-port output FIFO of wheel two for the selected port provided there is an FID in that per-port output FIFO. If there are no FIDs in the per-port output FIFOs for either wheel one or for wheel two for the selected port, then an FID can be removed from the per-port output FIFO of wheel three for the selected port, and so forth.

When DBS block 209 removes a FID from a per-port output FIFO, the DBS block 209 decrements the associated “DBS credit” value. As set forth above in the explanation of the input phase, the “DBS credit” value is incremented in the input phase at the configured shaping rate of the FID. The “DBS credit” value therefore indicates whether the shaper is lagging behind the unloading of the per-port output FlFOs or whether the shaper is leading the unloading of the per-port output FIFOs. If the shaper is lagging behind to a sufficient degree, then the “DBS credit” value may reach a negative value. If an EOP for such a shaped FID is reached and the associated “DBS credit” value is negative, then DBS block 209 does not continue sending this FID out (unloading this FID from the per-port output FIFO in subsequent output phases). Rather, DBS 209 suspends the unloading of this FID again until the shaper has incremented the DBS credit for this FID back up to a positive value.

Cells of different packets cannot be interleaved as they are output from an output port. Accordingly, once DBS block 209 has started removing an FID from a per-port output FIFO (whichever it picked from priority), it will not switch to start removing another FID within the same output port until it receives an EOP indication (indicating the last cell of the packet) back from PFQ block 207. DBS block 209 will also not switch from unloading a per-port output FIFO from one priority wheel to unloading a per-port output FIFO from another priority wheel until the EOP indication is reached. DBS block 209 is informed of the EOP indication via PFQ block 207 and line 234. If an EOP indication is not received for the current output phase, then DBS block 209 just decrements the “DBS credit” value associated with the FID and sends the FID to PFQ block 207 via CBWFQ block 208.

If, on the other hand, DBS block 209 receives an EOP for the current output phase, then there are two possibilities. If an EOP indication is received and the “DBS credit” is negative, then the FID is removed from the per-port output FIFO. The DBS credit being negative indicates that the shaper wheel is running slower than the unloading of per-port output FIFOs by DBS block 209. The FID is therefore not dequeued again until the negative DBS credit is incremented back to positive one. If an EOP indication is received and the “credit” is positive, then the “DBS credit” value is decremented and the FID is left in the per-port output FIFO. In this way, DBS block 209 removes FIDs from the per-port output FlFOs 303, decrements the associated “DBS credit” values, and forwards the FIDs to CBWFQ block 208 via lines 239.

For ease of explanation, we assume in this example that CBWFQ block 208 has not performed any merging of FIDs. The FID therefore passes through CBWFQ block 208 unchanged and is supplied to PFQ block 207 via lines 240. PFQ block 207 receives the FID, performs a “dequeue” operation on the queue for the indicated FID, and retrieves the BID of the next cell. The BID is then forwarded to memory manager block 204 in the form of a “dequeue command” via lines 223. PFQ maintains the per flow queues and a free buffer queue in external memories 218-220. Memory manager block 204, upon receiving the “dequeue command” for the BID, retrieves from payload memory 213 the cell data from the buffer identified by the BID. The retrieved cell data is then sent out of MS-SAR 124 via reassembly and header adding block 205 and outgoing interface block 206.

If shaper block 210 does not supply a FID back to DBS block 209 for the output port identified by port calendar 230, then a FID may be supplied by an output phase of scheduler block 211. Having an FID “scheduled” means that the flow will attempt to use all the free bandwidth available. The performance of a scheduled FID depends on the available bandwidth and the FID's own characteristics with respect to the other active flows in the system. As described above in connection with the input phase, every FID in the system is assigned a QOS class (the QOS class determines the relative priority of the FID with respect to other FIDS in other QOS classes) and an output port. Each output port may have an associated plurality of non-empty QOSs, and each such associated non-empty QOS may have a linked list of FIDs. The function of the scheduler is to choose one of the non-empty QOS classes for the output port, and then to choose one of the FIDs belonging to that QOS class. The resulting FID is the FID returned to DBS block 209.

Every output port in the system can be provisioned to have its own scheduling algorithm to choose the QOS class. The allowed scheduling algorithms are 1) strict priority, 2) weighted round robin, or 3) a mixture of both. For each output port, one QOS (the QOS number seven) is neither a strict priority QOS nor a weighted round robin QOS, but rather is reserved as a “best effort” QOS. The mixture of algorithms is provisioned by setting several of the highest seven priority QOS classes of a port to be selected between using the strict priority scheme, and setting the lower ones of the seven priority QOS classes of the port to be selected between using the weighted round robin scheme.

To select the QOS for the output port designated by port calendar 230, the scheduler block 211 uses the output port number to read a PREV_QOS field in the port par/descriptor memory 233 (see FIG. 16). This PREV_QOS field stores a three-bit value that designates the QOS that was services last for the output port. Once the scheduling out of FIDs for a QOS has started, the QOS number cannot be changed until an EOP indication has been received back from PFQ block 207. Accordingly, if no EOP is received back from PFQ block 207 for this output phase, then the QOS selected by output scheduler 211 is the previous QOS designated by PREV_QOS. If, on the other hand, an EOP for this QOS has been received, then a different QOS can be chosen as determined by the predetermined algorithm.

For each output port, the scheduler port parameter memory portion of the port par/descriptor memory 233 (see FIG. 15) stores an eight-bit PRIORITY field. There is one bit in this field for each of the eight QOSs of the port. Setting the bit associated with a QOS to a “1” designates the QOS as a strict priority QOS. Setting the bit associated with a QOS to a “0” designates the QOS as a weighted round robin QOS. The output scheduler block 211 uses the output port number received from port calendar 230 to look up the eight-bit PRIORITY field for the designated output port.

A QOS will be selected from the QOSs designated as strict priority QOSs if one of those QOSs is designated as being “not empty”. The output scheduler determines whether a QOS is empty by reading the bits in the QA_EMPTY field (see FIG. 16) in the port par/descriptor memory 233.

If a strict priority QOS is not selected, then output scheduler block 211 attempts to select a QOS from the QOSs designated as weighted round robin QOSs by the eight-bit PRIORITY field for the output port. To implement the weighted round robin scheme, a queue of QOSs is maintained for the output port. The three-bit value ACTIVE_PTR stored in port par/descriptor memory 233 identifies the next QOS in the queue to be serviced. If there is no QOS to select, then the best efforts QOS seven is selected to be the QOS.

Once a QOS is chosen, then output scheduler block 211 chooses one of the FIDs in the linked list of FIDs linked to the chosen QOS of the selected output port. To find the FID, the port number is multiplied by the number eight and the QOS number is added to this product. The result is an address that points to the F_RP read pointer (see FIG. 13) in the QOS par/descriptor memory 232. This F_RP read pointer points to the head of the linked list of FIDs that is linked to the selected QOS of the selected output port. Output scheduler 211 outputs this FID to DBS block 209 as the selected FID.

Once the FID is chosen, scheduler block 211 forwards the FID to DBS block 209. DBS block 209 determines whether the FID from the scheduler or a FID from the shaper will be sent out. If there is a FID from the shaper, then the FID from the shaper is sent out and the DBS causes the output phase of the scheduler to abort, thereby preventing the scheduler from updating any parameters and essentially undoing the scheduler output phase. If, on the other hand, there is no FID from the shaper, then the FID from the scheduler is sent out and the scheduler is allowed to update its parameters.

Data Base Block in More Detail:

MS-SAR 124 is provisioned such that port calendar 230 operates in one of two selectable modes: a non-work conserving mode, and a work-conserving mode. FIG. 18 is a diagram of a port calendar memory located in DBS block 209 that is used to implement port calendar 230.

Every sixteen 200 MHz system clocks, there can be one FID that is output form DBS block 209 via lines 239. In the non-work conserving mode, if there is no traffic for the output port designated by the port calendar, then there will be no FID sent from DBS block 209 to PFQ block 207 during that sixteen clock cycle period.

A work-conserving mode is therefore provided. In the work-conserving mode, the port calendar checks the status of the next port in the port calendar to see whether traffic is waiting to be output from that next output port. A SCH_AVAILABLE register is maintained in the DBS block. There is one bit in this register for each of the 64 output ports. After a dequeue, PFQ block 207 send an “empty” indication back to scheduler block 211 to indicate whether the last packet of the flow has now been sent. The scheduler block 211 knows whether this “empty” flow is the last flow for the designated output port. If the “empty” flow is the last flow for the designated output port, then scheduler block 211 updates the contents of the SCH_AVAILBLE register to indicate that the scheduler has no traffic waiting for that output port. There is also a SHP_AVAILABLE register maintained by DBS block 209. The SHP_AVAILABLE register indicates whether any of the per-port output FlFOs 303 for each output port has traffic waiting for that output port. There is also an SPIO_FULL register that indicates a “backpressure busy” condition in which so much traffic has been sent out on the output port that the output port is full (for example, the receiving egress MS-SAR is being overloaded due to too much traffic being sent out of that output port on the ingress MS-SAR).

In the work conserving mode, the port calendar 230 looks ahead to check the appropriate bits in the SCH_AVAILBLE register, and SHP_AVAILABLE register and SPIO_FULL register to determine if there is traffic waiting for, and whether traffic should be sent out of, the output port to be designated by the port calendar next. If there is no traffic waiting or if no traffic should be sent, then the port calendar skips that output port on the next sixteen clock cycle dequeue phase and selects an subsequent output port that does have traffic waiting. The number of FIDs output from DBS block 209 per unit time is therefore increased.

Scheduler in More Detail:

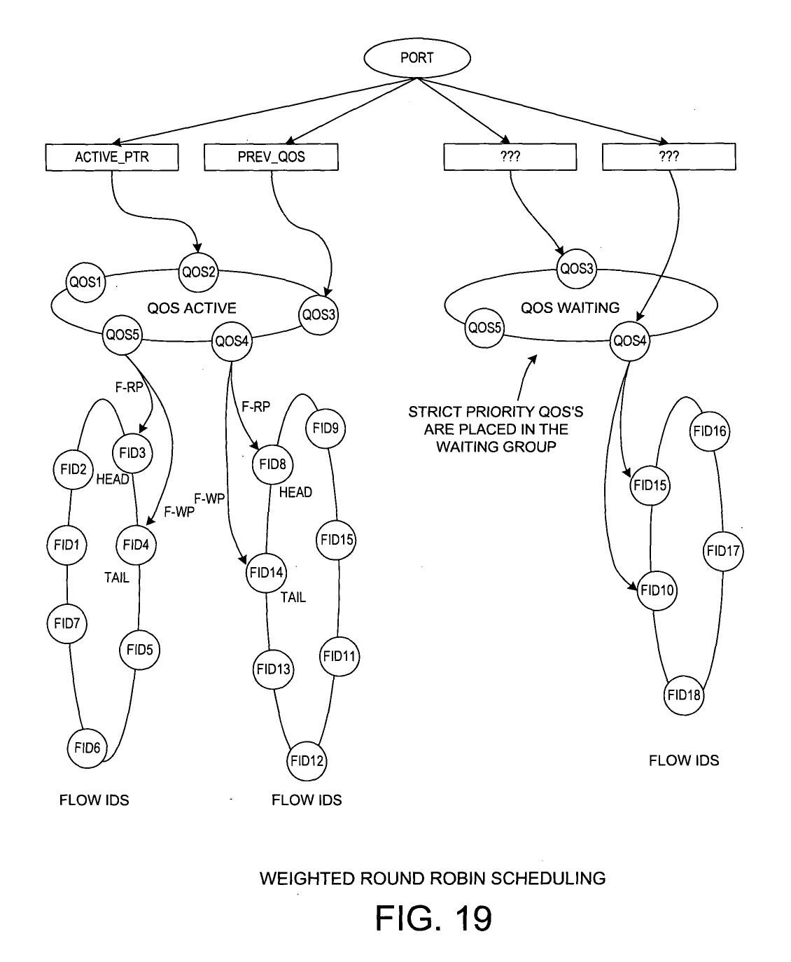

FIG. 19 is a diagram that illustrates how the weighted round robin scheme of selecting a QOS is carried out. In order to implement the weighted round robin algorithm, two groups of QOSs are maintained per port. One is the “active” group and the other is the “waiting” group. In FIG. 19, the three-bit value ACTIVE_PTR identifies the current QOS to be serviced in the “active” group. The three-bit value PREV_QOS identifies the previous QOS just serviced in the “active” group”.

In the input phase, strict priority QOSs that are not “empty” are linked into the waiting group. Strict priority QOSs are never present in the active group.

Weighted round robin QOSs pass between the active group and the waiting group. If a new weighted round robin QOS is to be put into a group due to an input phase, then the new QOS is put into the waiting group after the current cycle is done. When a weighted round robin QOS is placed into the waiting group (either upon an input phase or when being moved from the active group to the waiting group), its weight count is set to its original weight. The original weight of a QOS is calculated based on two values, a weight parameter which is stored per QOS in the QOS par/descriptor memory 233, and a WEIGHT_QUOTA value which is a programmable value that applies to all QOSs. The original weight of a QOS is the product of these two values.

When an output port is to be serviced, the “waiting” group is checked to determine if there are any strict priority QOSs that are not empty. This is done by reading the QW_EMPTY field. There is one bit in this QW_EMPTY field for each QOS to indicate whether the QOS in the waiting group is “empty” or not. If there are any strict priority QOS in the waiting group that are not empty, then these QOS are serviced first.

When all strict priority QOSs in the waiting group are empty, then non-empty QOSs can be selected in weighted round robin fashion from the active group. This is done by reading the QA_EMPTY field. There is one bit in the QA_EMPTY field for each QOS in the active group to indicate whether that QOS is empty or not. The Q_WEIGHT_MF value stored for the QOS (see FIG. 13) is a count down weight value of the amount of weight that the current QOS has left. After the current weighted round robin QOS is serviced, this Q_WEIGHT_MF value is decremented by WEIGHT_QUOTA. After the current weighted round robin QOS is serviced, the ACTIVE_PTR value is switched so that it points to the next weighted round robin QOS in the active group. When the count down weight value for a weighted round robin QOS reaches zero, then its weight is said to be exhausted. When a weighted round robin QOS in the active group has exhausted its weight, then it is moved to the waiting group. If the active group ever becomes empty, then all the non-strict priority QOSs in the waiting group are moved to the active group. When a non-strict priority QOS is placed into the active group, its Q_WEIGHT_MF weight count down value is reset to be it's original weight.

Once the QOS is selected, the associated FID linked to the selected QOS is determined by reading the F_RP pointer of the selected QOS. The FID pointed to by F_RP is sent to DBS block 209 as the scheduled FID. Upon this FID being sent to DBS block 209, there are two possibilities. The first possibility is that the linked list of FIDs is rotated. If the current cell being scheduled out is the last cell (in case of ATM traffic, every cell sent out will be marked as EOP), then the scheduler block 211 receives an EOP signal from DBS block 209. Also, if the current packet is the last packet linked for this FID, then scheduler block 211 receives an “empty” indication from DBS block 209. If an EOP signal is received but the FID is indicated as “not-empty”, then scheduler block 211 rotates the FID linked list. This is done by moving the just serviced FID from the head of the FID linked list to the tail of the FID linked list. The head pointer is changed to point to the next FID in the list, and the tail pointer F_WP is changed to point to the just serviced FID. The next FID in the list therefore becomes the head of the linked list.

The other possibility is that the just serviced FID is removed from the FID linked list. This is accomplished by changing the read pointer to point to the next FID in the list.

To prevent the interleaving of packets, the scheduler continues to service a QOS until an EOP is received for that QOS. This continued servicing occurs irrespective of priority.

Shaper in More Detail:

Shaper block 210 performs either single-leaky bucket shaping or dual-leaky bucket algorithm on an FID, depending on which one of a possible 4K sets of shaping profiles is provisioned to be the shaping profile for the particular FID. Up to 32K FIDs (or aggregated FIDs) can be shaped simultaneously. Which of the 4K shaping profiles is used to shape an FID is determined by the value RATE_ID (see FIG. 4) stored for the FID. FIG. 5 is a diagram of a shaping profile for one FID. The shaping profile includes several user-configurable values including: a threshold value THR, a “sustained rate” Ks, and a “peak rate” Kp. The units of THR is shaping credits. The units for Ks and Kp are timing wheel time slots. The sustained rate and the peak rate are stored as floating point numbers, so the shaping profile (see FIG. 5) contains an exponent portion and a mantissa portion for each.

For each FID, shaper block 210 maintains a “SHP credit” value (shaping credit). When an FID is to be linked to a timing wheel, the “SHP credit” value of the FID is checked. If the “SHP credit” value is less than the provisioned THR value for the FID, then the FID is to be shaped at the “sustained rate” Ks. If, on the other hand, the “SHP credit” value is more than the provisioned THR value for the FID, then the FID is to be shaped at the “peak rate” Kp. Once shaper block 210 has started shaping at the “peak rate” Kp, shaper block 210 continues shaping at the “peak rate” until the “SHP credit” value decreases to zero, at which point shaping at the “sustained rate” resumes.

If the “peak rate” and the “sustained rate” for an FID are provisioned to be the same, then effectively there is one rate and “single leaky bucket” shaping is implemented. Single leaky bucket shaping can also be set by writing a “0” to the PEAK_SUSTAIN bit for the FID in shaper internal FID#1 memory 228 (see FIG. 7).

If the “peak rate” is higher than the “sustained rate” and the PEAK_SUSTAIN bit is set to a “1”, then “dual leaky bucket” shaping is implemented.

In one embodiment, to provision the MS-SAR, a user supplies the following parameters to a driver program: a SCR value (sustained rate in cells/time units), a PCR (peak rate in cells/time units), a MBS (maximum burst size in cell units) and a CDVT (cell delay variation time). The driver program converts these values into the following values: the Ks value (number of timing wheel slots ahead to put the FID in a sustained rate), the Kp value (number of timing wheel slots ahead to put the FID in a peak rate), and the THR rate (a number of “SHP credits”). These values are then provisioned into MS-SAR 124 via CPU interface block 212.

Traffic shaper portion 227 includes a 19-bit time measurement counter. This counter is incremented once every eight cycles of the 200 MHz clock (the timing wheels also rotate once every eight cycles). When an FID is removed from the output FIFO of a timing wheel and is sent to the appropriate per-port output FIFO 303 in DBS block 209, the count of the counter used as a CURRENT timestamp. This CURRENT timestamp is compared with the timestamp recorded the last time this FID was similarly sent to DBS block 209. This last time value is retrieved from the LAST_TIME field in the shaper internal FID#1 memory 228 (see FIG. 7). The difference between the CURRENT timestamp and the LAST_TIME timestamp is the amount of time that elapsed between the sending of this FID to DBS block 209 this time and the last. This elapsed time value is divided by eight (because there are eight clock cycles per slot time), and the desired number of counter cycles (the sustained Ks value) is subtracted to obtain the “SHP_credit” value. If the elapsed time is smaller than the desired Ks value, then “SHP_credit” is negative. If the elapsed time is greater than the desired Ks value, then the “SHP_credit” value is positive. The “SHP_credit” value so calculated is then added to the prior accumulated “SHP_credit” value stored for this FID in the shaper internal FID#1 memory 228 (see FIG. 7). The resulting accumulated value is then written back into the “SHP_credit” field in shaper internal memory 228.

If the “SHP_credit” accumulated value exceeds the stored value THR, then the peak Kp shaping rate value is used to determine which slot of the timing wheel to reattach the FID to. If the “SHP_credit” value does not exceed the stored value THR, then the sustained Ks shaping rate value is used to determine which slot of the timing wheel to reattach the FID to.

Assume for illustration purposes here that the sustained Ks shaping rate is to be used. The FID cannot necessarily be reattached to the timing wheel Ks number of slots ahead. It may have been the case that this FID is one of many FIDs that were all attached to the same slot of the timing wheel. All these FIDs would then have been dumped into the output FIFO of the shaping wheel at once. Because only one FID can be moved from a shaping wheel output FIFO to DBS block 209 at a time, some of the FIDs may have stayed in the shaping wheel output FIFO for multiple time slot periods. If after this wait the FID were then reattached Ks slots in the future, then FID would be attached too far in the future.

To compensate for the amount of time an FID may have remained in a shaping wheel output FIFO, a timestamp is taken when the FID is placed (i.e., arrives) into the output FIFO. This timestamp value is the ARRIVAL_TIME value stored in shaper internal FID#1 memory 228 (see FIG. 7). The ARRIVAL_TIME value is subtracted the desired K (Ks, for example) value, and the resulting number K is the number of slots ahead in the timing wheel where the FID is reattached.

Tunneling:

MS-SAR 124 can be provisioned such that multiple selected ones of the regular traffic-carrying flows (called “leaf” FIDs) are aggregated together into a logical entity called a “root” FID or a “tunnel” FID. All the aggregated “leaf” FIDs associated with a “tunnel” FID can then be shaped together by shaping the “tunnel” FID. DBS block 209 implements this tunneling mechanism such that no other functional blocks with the MS-SAR are tunneling-aware. Up to 256K flows can be merged and shaped into up to 32K aggregated flows.

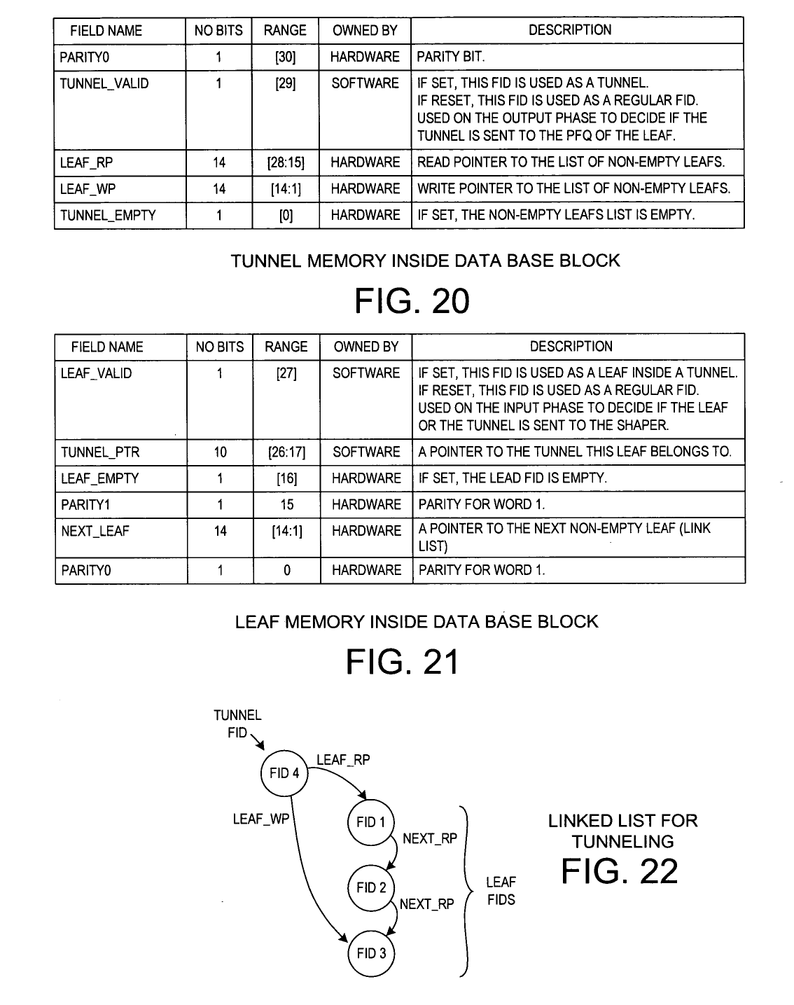

To implement tunneling, DBS block 209 includes two internal memories: a tunnel memory 241, and a leaf memory 242. FIG. 20 is a diagram of tunnel memory 241. There is one set of fields such as those shown in FIG. 20 for each FID. Accordingly, an incoming FID can be used to look up the associated TUNNEL_VALID field in tunnel memory 241 to determine whether the incoming FID is a tunnel or not. FIG. 21 is a diagram of leaf memory 242. There is one set of fields such as those shown in FIG. 21 for each FID. Accordingly, an incoming FID can be used to look up the associated LEAD_VALID in leaf memory 242 to determine whether the incoming FID is a leaf FID or not.

FIG. 22 is a diagram of a linked list structure used to implement a tunnel FID. In the illustrated example, there a three leaf FIDs (FID1, FID2 and FID3) aggregated together into one tunnel FID (FID 4). The TUNNEL_VALID field in tunnel memory 241 (see FIG. 20) for the tunnel FID (FID 4) is set to indicate that FID 4 is a tunnel FID. The LEAF_RP read pointer points to the first leaf FID (FID 1 in this example) of the linked list of leaf FIDs of this tunnel. The LEAF_WP write pointer points to the last leaf FID (FID 3 in this example) of the linked list of leaf FIDs of this tunnel. A leaf FID is made to point to the next leaf FID in the list by writing to the NEXT_LEAF field in the leaf memory of the leaf FID. In the present example, the NEXT_LEAF field in leaf memory 242 for FID 1 is made to point to FID 2.

To illustrate operation of tunneling, an example of an input phase is described wherein an FID is passed from CBWFQ block 208 to DBS block 209. If the incoming FID is a leaf of a tunnel and was empty before, then DBS block 209 links the FID to the appropriate tunnel linked list and sends the tunnel FID out of DBS block 209 to shaper block 210 in accordance with the input phase set forth above. DBS block 209 determines whether the incoming FID is leaf and whether the FID is empty by examining the LEAD_VALID and LEAF_EMPTY fields, respectively, for the incoming FID in leaf memory 241. If the incoming FID is determined to be a leaf, DBS block 209 identifies the tunnel FID for the leaf by reading the TUNNEL_PTR field in leaf memory 241. This field stores a pointer to the tunnel FID for this leaf FID.

Tunnel FIDs are not scheduled. Consequently, if a tunnel FID having leaves is to be output from DBS block 209, then DBS 209 sets the two bits accompanying the tunnel FID to indicate that the FID forwarded is to be received for an input phase by shaper block 210 but not by scheduler block 211. Shaper block 210 receives the FID from DBS block 209 and shapes the FID as if it were a regular FID having no leaves.

In the case where the forwarded FID is a tunnel with leaves, and shaper block 210 shapes the tunnel, the tunnel is then forwarded to the per-port output FIFOs 303 of DBS block 209 as described above. On an output phase of DBS block 209, when the FID is selected out of the per-port output FIFO, DBS block 209 checks tunnel memory 241. If the FID is not a tunnel, then the FID is forwarded to PFQ block 207 via CBWFQ lock 208.

If, on the other hand, the FID is a tunnel with leaves as determined by the contents of the tunnel memory, then DBS block 209 looks up the first leaf FID in the linked list of leaves (the leaf pointed to by LEAF_RP) and sends that FID out to PFQ block 207 via CBWFQ block 208. If an EOP is received from PFQ block 207, then DBS block 209 moves the leaf that was sent out from the head of the linked list to the tail of the linked list (i.e., rotates the linked list) by changing the LEAF_RP pointer to point to the next leaf in the list, by changing the last leaf in the list to point to the leaf that was sent out, and by changing the LEAF_WP to point to the leaf that was sent out. Accordingly, for a given tunnel FID received from shaper block 210, leaf FIDs are selected for passing to CBWFQ block 208 in round robin fashion.

If tunnel FIDs were to be allocated from the normal FID space, then a loss of FIDs would result. The number of FIDs available for use as regular unicast FIDs or another leaf FID would be reduced. To avoid this problem, the tunnel FID can be chosen as one of the leaf FIDs. This way, whenever a set of leafs are being tunneled, FID space does not have to be wasted to allocate a tunnel FID. Rather, the tunnel FID is selected as one of the leafs. Because FIDs can be shared between tunnels and leafs, however, care is taken to interpret FIDs correctly. Only leaf FIDs are exchanged between DBS block 209 and CBWFQ block 208. Only tunnel FIDs (with leaves or without leaves) can be exchanged between DBS block 209 and shaper block 210. It is an invalid condition to receive a tunnel FID from the PFQ. It is an invalid condition to receive a leaf FID from the shaper.

CBWFQ Block:

CBWFQ (Class-Based Fair Weighted Queueing) merges a number of flows into one root. The flows that are serviced are called CBWFQ leaf flows and the aggregate is called the CBWFQ root flow or virtual circuit (VC). The root flow is a regular flow which can be shaped (with or without funneling) or scheduled just like any other flow. The CBWFQ feature is typically used when multiple flows are to be merged onto one single ATM VC.

As in the case of tunneling described above, aggregated flows are stored in the form of linked lists of FIDs. When a merged flow is scheduled to be dequeued by the scheduling algorithms, one of the leafs is selected to be dequeued based on one of four algorithms: 1) round robin (RR), 2) deficit round robin (DRR), 3) Alternate modified deficit round robin (MDRR), and 5) strict priority and modified deficit round robin.

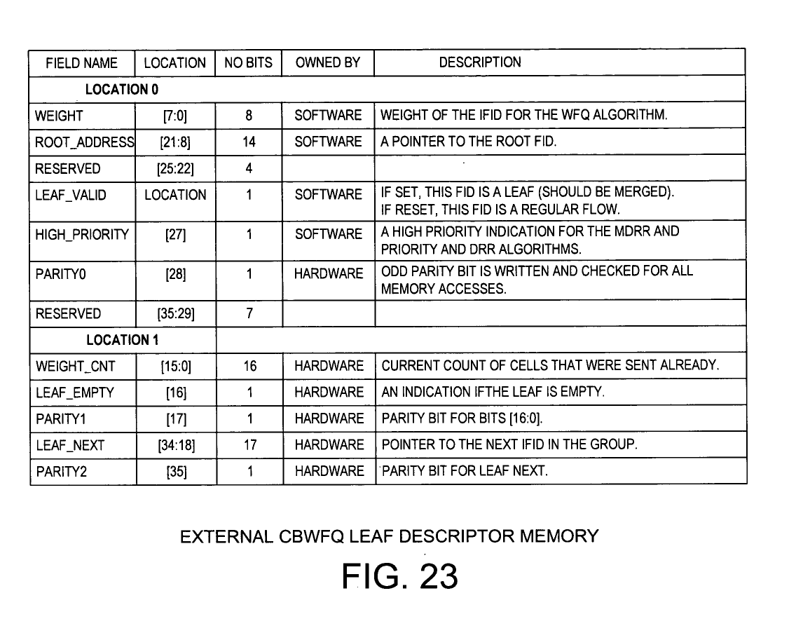

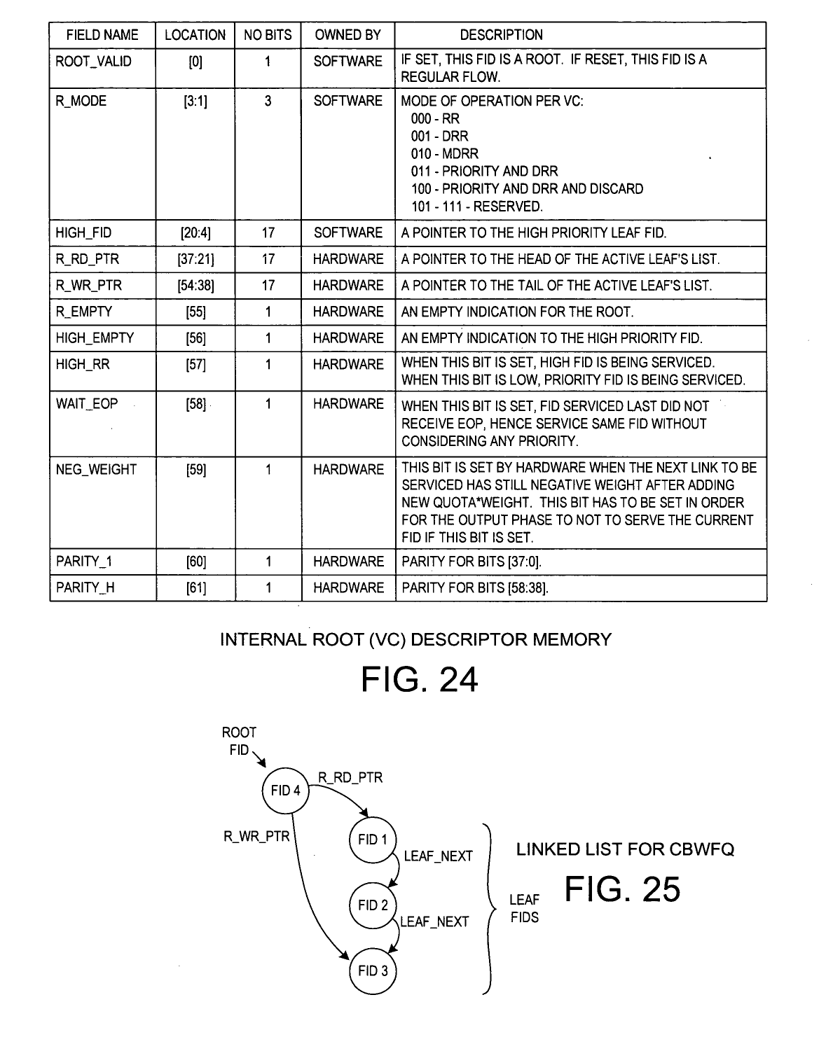

CBWFQ block 208 utilizes two memories: external CBWFQ leaf descriptor memory 217, and an internal root (VC) descriptor memory 243. FIG. 23 is a diagram of external leaf CBWFQ descriptor memory 217. FIG. 24 is a diagram of internal VC (root) descriptor memory 243. FIG. 25 is a diagram that shows how the merged FIDs of a VC are maintained in a linked list form.

In an input phase, an FID is received from PFQ block 207. If the incoming FID is a leaf, and if the leaf is empty (there is not traffic pending from this leaf FID), then CBWFQ block 208 marks the leaf as “not empty”, looks up the associated root, links the incoming FID into the linked list of the root, and then marks the root as “not empty”. Designating the root as “not empty” means that there is a linked list of leafs (non empty leaves) for the root. CBWFQ block 208 then sends the root FID to DBS block 209. This entire operation is bypassed if the FID does not belong to a root FID.

In an output phase, CBWFQ block 208 receives an FID from DBS block 209. If the FID is a root FID, the CBWFQ selects one of the leaf FIDs to be sent to PFQ block 207. If in response to sending a leaf FID to PFQ block 207 an empty indication is received back, then CBWFQ block 208 remove the leaf FID from the linked list of FIDs for its root. If an EOP indication is received from PFQ block 207, then CBWFQ block 208 rotates the linked list of FIDs in accordance with the particular algorithm selected. The rotation is performed in similar fashion to the way the linked list of FIG. 22 was rotated. The entire operation of CBWFQ block 208 is bypassed if the FID received from DBS block 209 is not a root FID (VC).

RR: This is a simple round robin scheme. Once an EOP indication arrives from the PFQ block 207, the linked list of leaf FIDs is rotated.

DRR algorithm: This is a weighted round robin algorithm with the ability to support negative credit. Once an EOP indication arrives from PFQ block 207, if the FID has a zero or negative weight it will be rotated to the end of the linked list. When this FID comes up for servicing again, if credit is still negative, then no output phase is performed but rather a new weight quota is added and is pushed back to end of link.

MDRR algorithm: This is an extension of the DRR algorithm. One FID is considered to be of higher priority than the others. If is therefore not linked to the list. The rest of the FIDs are considered as one group. There is a pure round robin between this high priority FID and the group so that the scheduling look like: FID, group, FID, group, FID, group, and so forth. When it is the turn of the group, an FID is selected based on the DRR algorithm.

Priority and DRR and Discard: This is another extension to DRR. This mode is the same as the previous one, except that if the high priority FID is not empty, then it is sent to PFQ block 207 without consideration to its weight. Only if the high priority FID is empty will the rest of the FIDs be transferred to the PFQ block 207 based on the DRR scheme.

### Example of Traffic Management Capabilities

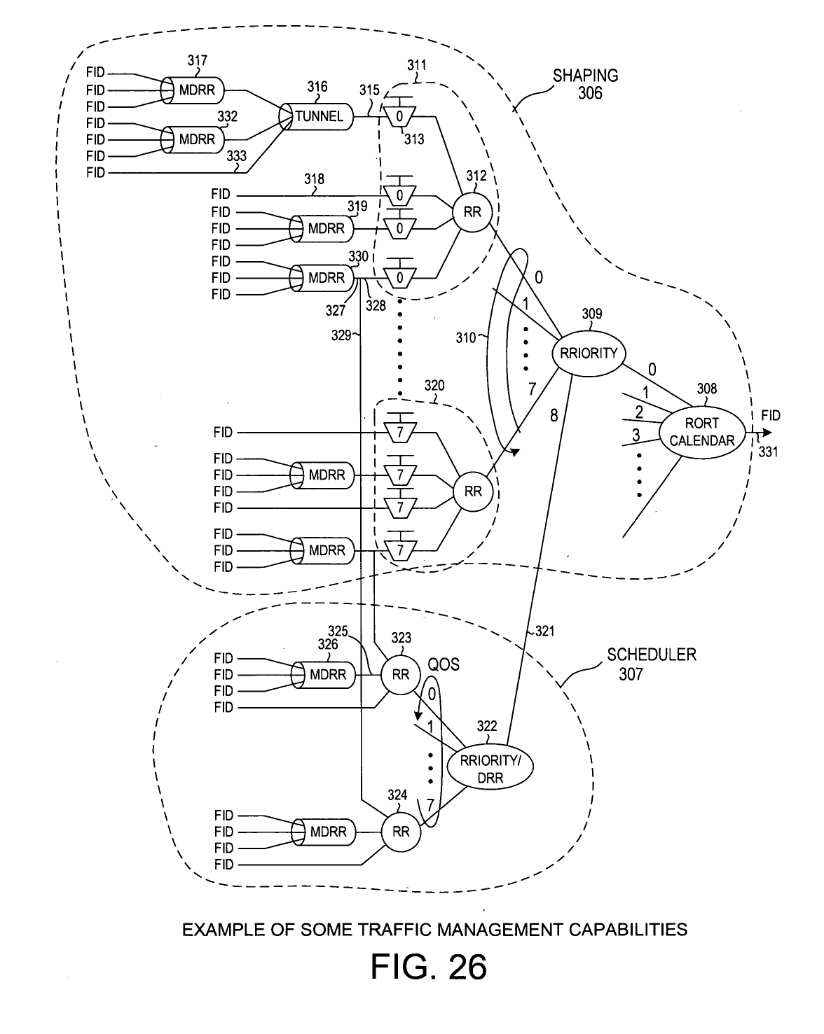

FIG. 26 illustrates an example of some of the traffic management capabilities of MS-SAR 124 wherein an FID is selected and is supplied to PFQ block 207 in an output phase. Portion 306 is generally considered to be a shaping function whereas portion 307 is generally considered to be a scheduling function. Bubble 308 represents the operation of port calendar 230. As set forth in the description of the port calendar above, the output phase starts with port calendar 230 selecting an output port. Which output ports are selected and in what order is determined by how port calendar 230 is provisioned. Port calendar 230 in the example of FIG. 26, selects one of the output ports represented in the diagram as lines extending from the left of bubble 308. In the example of FIG. 26, the top output port (port number 0) is selected.

Once port 0 is selected, the selection proceeds to the left to bubble 309. Bubble 309 represents the selection by DBS block 209 of an FID from one of the per-port output FIFOs from one of the eight shaper timing wheels (represented here by the eight lines numbered 0-7 that extend to the left from bubble 309), or if there is no FID output by the shaper block then an FID output by scheduler block 211 is selected (represented here by the bottom line numbered 7 that extends downward and to the left from bubble 309). Priorities 0-7 are for shaped traffic. The selection of FIDs from the per-port FlFOs-of wheels 0 through 7 are by strict priority. This is represented by arrow 310. Priority 8 is for scheduled traffic.

Portion 311 represents shaping done by shaper wheel 0 (the highest priority shaping wheel). The “RR” in bubble 312 represents the round robin algorithm, and the bucket symbol 313 represents leaky bucket shaping (either single leaky bucket or dual leaky bucket). A shaping wheel can be provisioned to shape three types of elements: 1) ordinary FIDs, 2) tunnel root FIDs, and 3) MDRR root FIDs.

In the particular example of FIG. 26, if shaper 0 selects an FID on line 315 then a tunnel FID is shaped. As set forth in the description of tunneling above, when the tunnel FID passes through DBS block 209, one of its leaf FIDs is selected, and the selected leaf FID is then output from DBS block 209 to CBWFQ block 208. In the example of FIG. 26, tunnel symbol 316 has three associated leaf FIDs. These leaf FIDs are represented in FIG. 26 by the three lines extending to the left from tunnel symbol 316.

A tunnel can be set up to aggregate regular FIDs and MDRR elements. Tunnel 316 in FIG. 26 illustrates this. Tunnel 316 aggregates two MDRR elements 317, 332 and one regular FID 333. If the upper leaf FID is selected by the tunnel mechanism, the resulting FID in the example of FIG. 26 is actually an “MDRR” FID. As set forth above, CBWFQ block 208 receives an MDRR root FID and selects one of the associated leaf FIDs. In the example of FIG. 26, MDRR 317 has three associated leaf FIDs. Which of these leaf FIDs is selected depends on how the MDRR root flow is provisioned.

In addition to selecting a tunnel FID, a shaper wheel can also shape an ordinary FID. This is illustrated in FIG. 26 by FID 318. A shaper wheel can also shape an MDRR root FID. This is illustrated in FIG. 26 by MDRR 319.

Once DBS block 209 receives an EOP, DBS block 209 can select an FID from the highest priority per-port output FIFO of shaper block 210. In the example of FIG. 26, if there is no such FID in the per-port output FIFO for shaper wheel 0, then an FID can be taken from the per-port output FIFO for shaper wheel 1 (represented by the line labeled “1” extending to the left from priority bubble 309). Similarly, if there is no FID in any of the per-port output FIFOs for shaper wheels 0-5, then DBS block 209 can select an FID from shaper wheel 7. Shaper wheel 7 is represented by portion 320.

If there is no FID to select from shaper block 210, then an FID can be supplied via line 321 from scheduler block 211. The lines extending from the left of priority/DRR bubble 322 represent the QOS classes that may be provisioned. As set forth in the description of scheduler block 211 above, a number of the highest priority QOSs can be provisioned to be selected between using a strict priority scheme, and the remaining QOSs (but for QOS 7) can be provisioned to be selected between using a weighted round robin scheme. QOS 7 is selected on a best efforts basis. For the QbS selected, the scheduler selects an element from a linked list linked to the selected QOS. Two types of elements can be scheduled: 1) regular FlDs, and 2) MDRR root FIDs. Which element is selected is determined using a round robin scheme. This is represented in FIG. 26 by the “RR” in the bubbles 323 and 324 to the left of the QOS numbers. An element in one of these linked lists can be an MDRR root. This is illustrated in FIG. 26 by line 325 extending to the left from bubble 323 to MDRR symbol 326. When the MDRR root FID 326 passes from scheduler 211 through CBWFQ block 208, CBWFQ block 208 selects one of the leaf FIDs associated with MDRR root FID 326. These leaf FIDs are represented in FIG. 26 by the three lines extending to the left from MDRR symbol 326. CBWFQ block 208 then selects one of these leaf FIDS in accordance with the algorithm provisioned for the root, and forwards that selected leaf FID to PFQ block 207.

MS-SAR 124 can be provisioned to both shape and schedule an FID. This is represented by FID 327 passing to the right via line 328 to shaper wheel 0 or passing down to QOS 7 being scheduled via line 329. Note that this FID 327 that is both shaped and scheduled may be an MDRR flow as indicated by MDRR symbol 330.

The FID produced by the traffic management structure of FIG. 26 for the selected output port is then supplied to PFQ block 207 for dequeuing. This is represented in FIG. 26 by arrow 331.

Although the present invention is described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. An apparatus for managing a plurality of flows of network information, each flow being identified by a flow identifier (FID), the flows passing out of the apparatus via a plurality of output ports, each flow being stored as one or more cells, each cell being stored in a buffer, each buffer being identified by a buffer identifier (BID), the apparatus comprising:
a port calendar, the port calendar identifying for servicing one of a plurality of output ports;
a shaper, the shaper shaping a subset of the plurality of flows and outputting a plurality of FIDs, each FID output by the shaper representing a cell of a FID shaped by the shaper;
a scheduler that selects one of a plurality of classes, each class being a class of a plurality of flows, a plurality of such classes being associated with each output port, the scheduler selecting one of the flows in a class associated with the selected output port, the scheduler outputting an FID that identifies the one selected flow, the FID output by the scheduler representing a cell of a FID scheduled by the scheduler; and
a dequeue mechanism that retrieves a BID in response to receiving an FID, wherein if the shaper outputs a FID associated with the output port selected by the port calendar then the dequeue mechanism retrieves a BID associated with the FID output by the shaper, and wherein if the shaper does not output an FID associated with the selected output port and if the scheduler outputs a FID associated with the selected output port then the dequeue mechanism retrieves a BID associated with the FID output by the scheduler, wherein the port calendar, shaper, scheduler and dequeue mechanism are all part of a single integrated circuit.

2. The integrated circuit of claim 1, wherein the apparatus is configurable so that a single flow is both shaped by the shaper and is also scheduled by the scheduler.
